(19) United States
(12) Patent Application Publication
(10) Pub. No.: US 2012/0048927 A1
(43) Pub. Date: Mar. 1, 2012

(54) CODE READING DEVICE AND CODE READING METHOD

(75) Inventor: Keiichi Hasegawa, Tokyo (JP)

(73) Assignee: TOSHIBA TEC KABUSHIKI KAISHA, Tokyo (JP)

(21) Appl. No.: 13/219,837

(22) Filed: Aug. 29, 2011

(30) Foreign Application Priority Data
Sep. 1, 2010 (JP) 2010-196165

(51) Int. Cl. G06F 17/30; G06K 7/14

(52) U.S. Cl. 235/383; 235/375; 235/454

(57) ABSTRACT

A code reading device according to the embodiment includes, an image capturing unit, a code reading unit, and an information reading unit. The image capturing unit captures an image taken by an imaging element. The code reading unit reads code information included in a code symbol, from an image of the code symbol which is included in the captured image taken by the image capturing unit. The information reading unit reads information relating to a product, which is overlapped with the image of the code symbol, from the image of the code symbol.

### CROSS-REFERENCE TO RELATED APPLICATION

This application is based upon and claims the benefit of priority from Japanese Patent Application No. 2010-196165, filed on Sep. 1, 2010, the entire contents of which are incorporated herein by reference.

### FIELD

Embodiments described herein relate generally to a code reading device and a code reading method.

### BACKGROUND

When managing the shelf life of a product in a store, for example, the shelf life is printed on a label, and the label is attached to each product. In addition, a discount label is attached to a product the shelf life of which is close to expiry. In general, these labels are attached to a position near a code symbol in which a code for specifying each product is symbolized. A clerk of the store checks contents of the label attached to each product in order to sell a product for which the shelf life is near expiry at a reduced price, or to dispose of a product the shelf life of which is expired.

In addition, a technology of a scanner is developed, in which a code symbol attached to each product and labels attached around the code symbol (a label showing the shelf life or a discount label) are imaged, which reads out a product code and information on the shelf life, or discount information from the captured image.

However, when the product is small or the label is desired to be small, since there is not enough space for attaching information on the shelf life, or the like, in the vicinity of the code symbol, information on the shelf life, or the like, is desired to be printed on the code symbol in an overlapping manner.

### DESCRIPTION OF THE DRAWINGS

FIG. 1 is a perspective appearance view schematically showing a configuration of a checkout lane system having a code reading device, according to the present embodiment.

FIG. 2 is a block diagram for showing a configuration of the code reading device.

FIG. 3 is a diagram showing an example of a relationship between a product and an imaging area of a camera.

FIG. 4 is a diagram showing an image in a barcode area which is read out.

FIG. 5 is a diagram showing a part of an image of a barcode symbol, in which all of the code lines are aligned in the width direction of the barcode symbol.

FIG. 6 is a diagram showing an image of an area where the shelf life is printed, as a part of image which is not the code symbol.

FIG. 7 is a diagram showing an example of an error message displayed in a display for a clerk.

FIG. 8 is a flow chart for showing a sequence of information reading processes which is executed by the code reading device.

FIG. 9 is a diagram showing another description method of information which is related to a product.

### DETAILED DESCRIPTION

A code reading device according to the embodiment includes an image capturing unit, a code reading unit, and an information reading unit. The image capturing unit captures an image taken by an imaging element. The code reading unit reads code information included in a code symbol, from an image of the code symbol which is included in the captured image taken by the image capturing unit. The information reading unit reads information relating to a product, which is overlapped with the image of the code symbol, from the image of the code symbol.

In addition, a code reading method according to the embodiment is performed in the code reading device, and includes an image capturing process, a code reading process, and an information reading process. In the image capturing process, an image taken by an imaging element is captured. In the code reading process, code information included in a code symbol is read, from an image of the code symbol which is included in the captured image taken in the image capturing process. In the information reading process, information relating to a product, which is overlapped with the image of the code symbol is read, from the image of the code symbol.

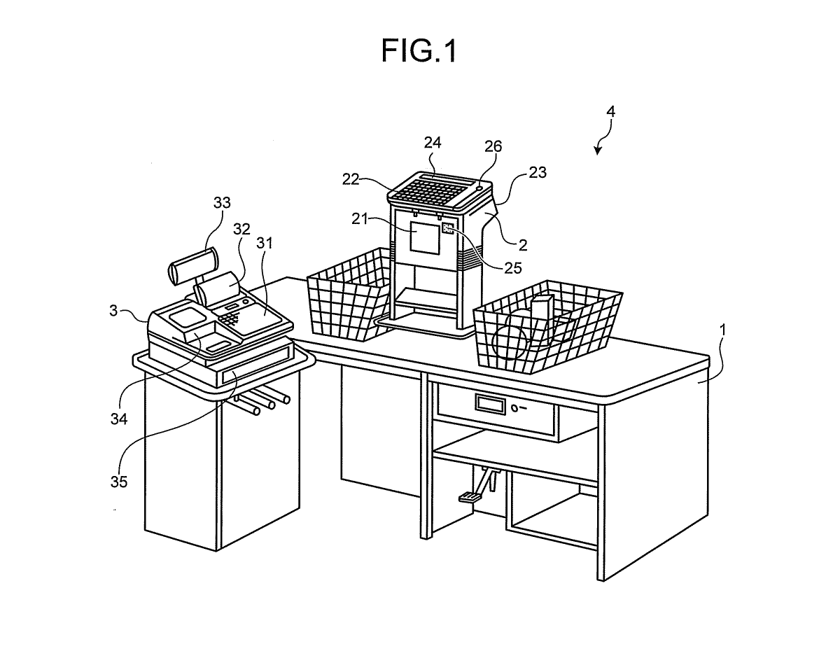

FIG. 1 is a perspective view for schematically showing a configuration of a check-out lane system 4, which includes a code reading device 2 according to the embodiment. As shown in FIG. 1, the check-out lane system 4 includes a checkout counter 1 for placing a shopping basket in which products are put, a code reading device 2 which is provided substantially at the center of the checkout counter 1, and a POS (Point of Sales) terminal 3 which is connected to the code reading device 2 to be able to communicate with each other through a transmission path which is not shown.

The POS terminal 3 performs a sales registration of a product purchased by a customer. As shown in FIG. 1, the POS terminal 3 is provided with a keyboard 31, a operator display 32, a customer display 33, a printer 34 for printing a receipt or the like, a drawer 35 for receiving cash or the like, and the like. The keyboard 31 is installed with a total key which is necessary for a payment for the product. The POS terminal 3 has the same configuration and function as those of a POS terminal which is used as a standard in this type of check-out lane system.

The code reading device 2 is a device which reads out a barcode symbol, which is shown in the product and outputs product information included in the barcode, which is shown by the barcode symbol, to the POS terminal 3. As shown in FIG. 1, the code reading device 2 is mainly provided with a reading window 21, a keyboard 22, a display 23 for a customer, a display 24 for a clerk, an LED (Light Emitting Diode) 26, and a buzzer 25. The keyboard 22 receives input from various keys, when performing a registration of a product which is not possible to register by reading the barcode symbol, for example. The display 23 for a customer displays a price, a product name, or the like, which is registered, to the customer.

The display 24 for a clerk displays a price, a product name, or the like, which is registered, to the clerk, who is an operator. In addition, the display 24 for a clerk displays an error message, when the shelf life of the product is expired.

The LED 26 informs the operator that the barcode symbol, which is shown on the product, is properly read, by lighting up.

The buzzer 25 notifies the operator that the shelf life of the product is expired, by buzzing.

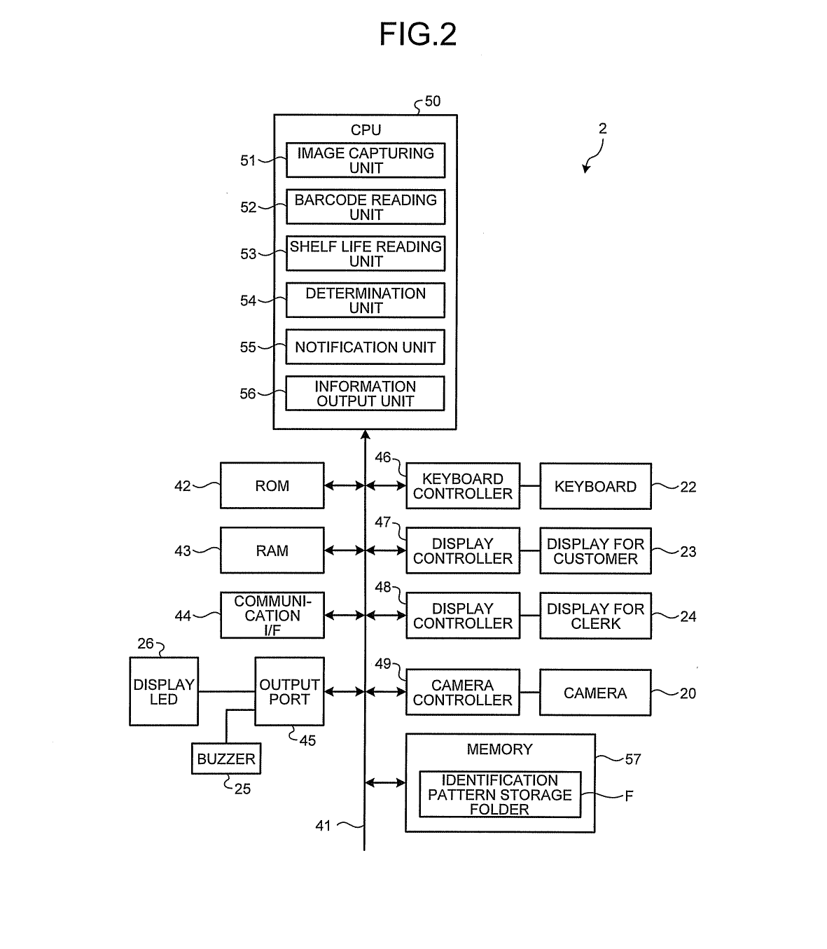

A camera 20 (refer to FIG. 2) is embedded in the code reading device 2, in which the reading window 21 is provided. The camera 20 may be an imaging device using, for example, a CCD (Charge Coupled Device), or may be an imaging device using another imaging element, such as a CMOS (Complementary Metal Oxide Semiconductor). The camera 20 takes an image of a product which is placed on an imaging area which is opposite the reading window 21.

FIG. 2 is a block diagram for showing a configuration of the code reading device 2. The code reading device 2 is mainly provided with a CPU 50, a ROM 42, a RAM 43, a communication I/F 44, an output port 45, a keyboard controller 46, display controllers 47 and 48, a camera controller 49, and a nonvolatile memory 57. These are configured to be connected through a bus line 41 such as an address bus, a data bus, or the like.

The CPU 50 functions as a control unit for controlling entire operation of the code reading device 2. The ROM 42 stores a program according to the embodiment, another program for controlling an operation of the CPU 50, or the like. The RAM 43 functions as a work area when various programs stored in the ROM 42, is expanded by the CPU 50. In addition, the RAM 43 stores a variety of data, such as image data which is captured by the camera 20.

The communication I/F (Interface) 44 controls data communication between the communication interface and the POS terminal 3 (refer to FIG. 1), which is connected via the bus. The output port 45 outputs a driving signal to the buzzer 25 and the LED 26. The keyboard controller 46 takes in a key signal from the keyboard 22. The display controller 47 controls a data display with respect to the display 23 for a customer. The display controller 48 controls a data display with respect to the display 24 for a clerk. The camera controller 49 controls an imaging operation of the camera 20.

The memory 57 stores an identification pattern storage folder F in which information is identified by identifying a character, an illustration, a symbol, or the like. The identification pattern storage folder F stores a pattern for identifying characters, which is generally used in OCR (Optical Character Reader).

Subsequently, a characteristic function of the code reading device 2 according to the embodiment will be described. The CPU 50 functions as an image capturing unit 51, a barcode reading unit 52, a shelf life reading unit 53, a determination unit 54, a notification unit 55 and an information output unit 56, as shown in FIG. 2, by operating according to a program stored in the ROM 42, which is expanded in the RAM 43.

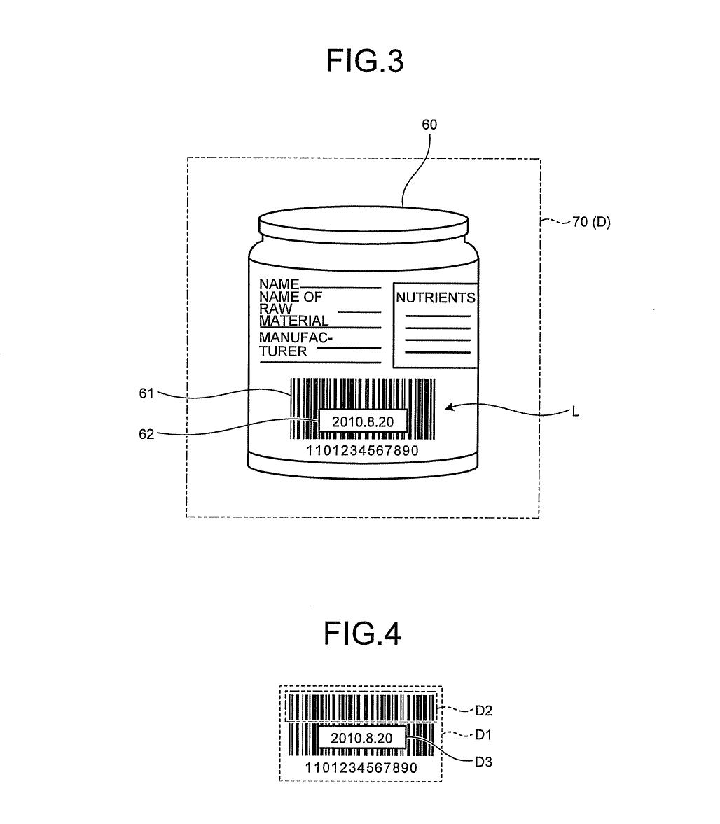

The image capturing unit 51 causes the camera 20 to start an image capturing operation by outputting an on signal for imaging to the camera controller 49. The image capturing unit 51 captures an image D (refer to FIG. 3) in the imaging area 70, which is taken by the camera 20, and stores the image in an image work area of the RAM 43.

FIG. 3 is a diagram showing an example of a relationship between a product 60 and the imaging area 70 of the camera 20. The area surrounded by two dot chain lines in the figure is the imaging area 70, which is an area where the camera 20 can capture images in one frame. A label L, in which product information, such as a product name or name of raw materials, a barcode symbol 61, or the like, is described, is attached to the product 60 which is shown in FIG. 3.

Information, such as a product code, which is necessary as product information when registering sales data of the product 60 using the POS terminal 3 is included in the barcode symbol 61. In addition, a product code “1101234567890”, which is shown by the barcode symbol 61, is numerically displayed in the lower part of the barcode symbol 61.

As shown in FIG. 3, a shelf life print area 62 is provided in a part of the barcode symbol 61. The barcode symbol 61 is printed along with the product name, or the like, when printing the label L, however, in this case, the shelf life print area 62 is left white, so that the shelf life may be printed later. In addition, it is possible to print a display of the shelf life on a label with approximately the same size as the shelf life print area 62, and to overlap the label with the shelf life print area 62.

In this manner, it is possible for the information on the product, such as the shelf life, to be included in the image of the barcode symbol 61 without changing the original design of the label L. In addition, the image capturing unit 51 can simultaneously capture images of the barcode symbol 61 which is included in the imaging area 70, and images of the shelf life print area 62.

The barcode reading unit 52 detects an image D1 of the barcode symbol 61 in the image D, which is stored in the RAM 43, as shown in FIG. 4. That is, the barcode reading unit 52 performs binarization of the image data of image D of one frame, which is stored in the image work area of the RAM 43, and detects an image of the data area, as the image D1 of the barcode symbol 61, when a data area related to the barcode symbol 61 is present in the binarized data.

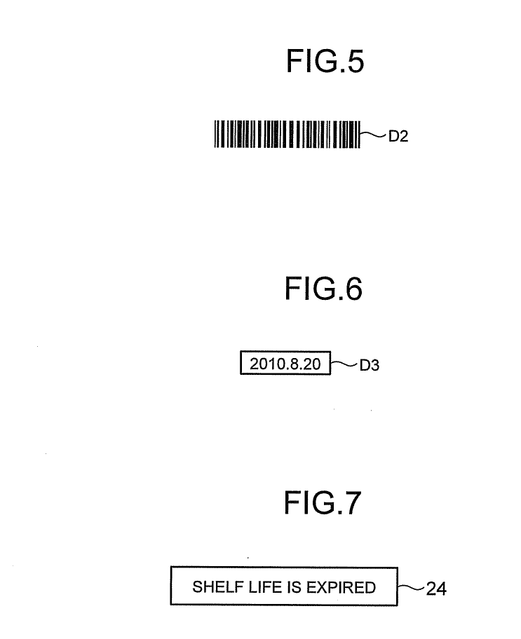

In addition, as shown in FIG. 5, the barcode reading unit 52 extracts an image D2 at a portion where the entire code line is aligned in the width direction of the barcode symbol 61, from the image D1, in the barcode symbol 61.

Further, the barcode reading unit 52 decodes the barcode symbol 61 from the image D2, and reads out the barcode data as product information of the product 60. The barcode data includes a manufacturer code, a product code as product information, check digit, or the like. The barcode reading unit 52 stores the read barcode data in the barcode work area of the RAM 43.

In addition, a shelf life reading unit 53 detects, from the image D1 of the barcode symbol 61, an image D3 (an image other than a black bar, a white bar, and a black dot, which configure the code symbol) which is overlapped with the barcode symbol 61, and is not the code symbol. In examples shown in FIGS. 3 and 4, the barcode reading unit 52 detects an image of the shelf life print area 62 as the image D3 which is overlapped with the barcode symbol 61, as shown in FIG. 6.

In addition, the shelf life reading unit 53 reads out the shelf life of the product 60 as information related to the product 60, from the image D3 (an overlapped image), which is overlapped with the barcode symbol 61. That is, the shelf life reading unit 53, by referring to the pattern stored in the identification pattern storage folder F, specifies the characters and symbols which are written in the shelf life area 62 and reads the shelf life of the product 60. In addition, the shelf life reading unit 53 stores shelf life information of the product 60 which is read out in a service code work area of the RAM 43.

The determination unit 54 determines whether or not the shelf life of the product 60 is expired by comparing the current data to the shelf life which is read out by the shelf life reading unit 53.

When the shelf life of the product 60 is determined to be expired by determination unit 54, the notification unit 55 sounds the buzzer 25 and displays an error message of “the shelf life is expired”, or the like, on the display 24 for a clerk, as shown in FIG. 7, by controlling the display controller 48.

The information output unit 56 outputs the barcode data which is stored in the RAM 43 by the barcode reading unit 52, to the POS terminal 3 through the communication I/F 44. The POS terminal 3 performs a sales registration of the product 60 using the received barcode data.

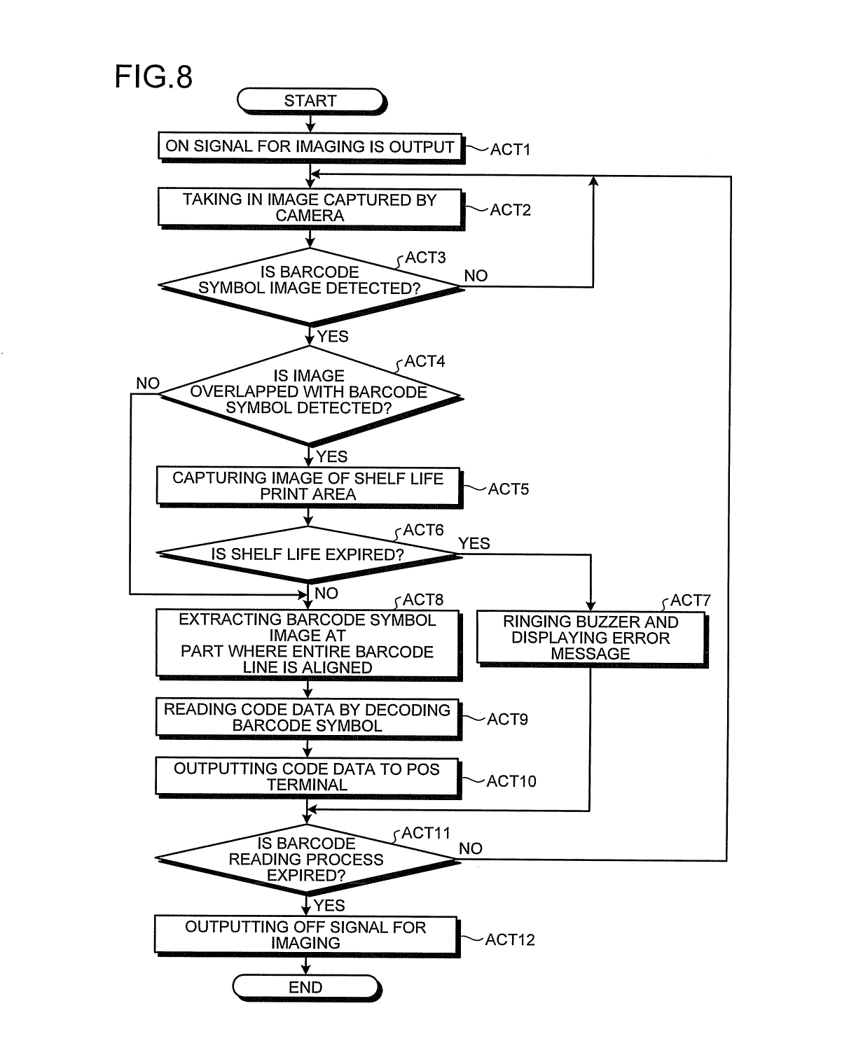

Subsequently, an information reading process performed by the code reading device 2 will be described with reference to FIG. 8. FIG. 8 is a flow chart showing a sequence of the information reading process which is performed by the code reading device 2. When an instruction to start scanning is received from the POS terminal 3, the image capturing unit 51 outputs an on signal for imaging to the camera controller 49, and starts imaging operation, using the camera 20 (Act 1).

The image capturing unit 51 takes image data of an image D which is captured by the camera 20, in the image work area of the RAM 43 (Act 2).

The barcode reading unit 52 determines whether or not the image D1 of the barcode symbol 61 is detected in the image D (Act 3). When the image D1 of the barcode symbol 61 is not detected (No, in Act 3), the barcode reading unit 52 continues image capturing using the camera 20 (Act 2).

When the image D1 of the barcode symbol 61 is detected (Yes, in Act 3), the shelf life reading unit 53 determines whether or not the image D3 which is overlapped with the barcode symbol 61, and is not the code symbol, is detected in the image D1 (Act 4). When the image D3 which is overlapped with the barcode symbol 61 is not detected (No, in Act 4), the process moves to Act 8 and the barcode reading process is performed.

On the other hand, when the image D3 which is overlapped with the barcode symbol 61 is detected (Yes, in Act 4), the image D3 is detected as the shelf life print area 62, and the image D3 of the shelf life print area 62 is captured in the image work area of the RAM 43 (Act 5).

The determination unit 54 determines whether or not the shelf life of the product 60 is expired by comparing the current date to the shelf life which is read out by the shelf life reading unit 53 (Act 6).

When the shelf life of the product 60 is expired (Yes, in Act 6), the notification unit 55 sounds the buzzer 25 and displays an error message of “the shelf life is expired” on the display 24 for a clerk (Act 7), and then moves to Act 11.

When the shelf life of the product 60 is not expired (No, in Act 6), the barcode reading unit 52 extracts a portion of the image D2 where the entire code line is aligned in the horizontal direction of the barcode symbol 61, in the barcode symbol 61 (Act 8). Further, the barcode reading unit 52 reads out code data by decoding the barcode symbol 61 from the image D2 (Act 9).

The information output unit 56 outputs code data which is read by the barcode reading unit 52, to the POS terminal 3 (Act 10). The POS terminal 3 performs a sales registration of the product, using the received code data.

The code reading device 2 determines whether or not an instruction to end the barcode reading process is made, after finishing the sales registration process, from the POS terminal 3 (Act 11). When the instruction to end the barcode reading process is not made (No, in Act 11), the code reading device 2 returns to Act 2, and continues the barcode reading process after the Act 2. When the instruction to end the barcode reading process is made (Yes, in Act 11), the code reading device 2 outputs an off signal for imaging to the camera controller 49 (Act 12) and ends imaging by the camera 20.

As described above, according to the embodiment, when the image D3, which is not the code symbol, is overlapped with the barcode symbol 61, both of the code data of the barcode symbol 61 and information shown by the image D3 which is overlapped with the barcode symbol 61 can be read.

In addition, a program executed by the code reading device 2 according to the embodiment, is provided by being embedded in the ROM 42 or the like, in advance. Programs which are executed by the code reading device 2 according to the embodiment, include files in an executable or installable format, and may be provided by being recorded on a recording medium which can be read by a computer, such as a CD-ROM (Compact Disc-Read only Memory), a flexible disk (FD), a CD-R (Compact Disc Recordable), a DVD (Digital Versatile Disc), or the like.

In addition, the program executed by the code reading device 2 according to the embodiment may be stored in a computer which is connected to a network, such as the Internet, and provided by being downloaded through the network. In addition, the program executed by the code reading device 2 according to the embodiment may be provided or distributed through a network, such as the Internet.

Further, in the above description, a case is described where the shelf life as the information on the product is displayed on the barcode symbol, however, the information is not limited thereto. As another example, the factory which manufactured the product, the production line of the product, the production district or the producer of the product, lot number, sample indicator showing that the product is free, or the like, can be displayed on the barcode symbol.

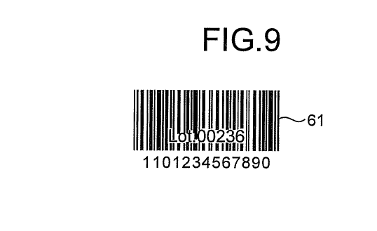

Further, in the above description, the shelf life print area 62 is provided left white on the barcode symbol 61 in advance, so as to print the shelf life when manufacturing the product. However, the description method of information on the product is not limited thereto. As another example, as shown in FIG. 9, it is preferable that the barcode symbol 61 is printed as in the past, and the information on the product is printed on the barcode symbol 61 using a color ink, in an overlapping manner, when manufacturing the product. In this case, an imaging process is performed on the image D1 which is taken, and information (lot number, or the like) on the product is read, using the differences of colors and contrast.

In addition, the code reading device 2 according to the embodiment may be applied to a system which manages inventory of the product. As an example, when the lot number of the product, or the like, is printed on the barcode symbol in an overlapping manner, and the product is recalled or discontinued, the barcode symbol printing portion is scanned by a scanner and the lot number is read. Further, when it is determined that the read lot number is the lot number which is recalled or discontinued, the code reading device 2 notifies that it is the lot number which is recalled or discontinued. In this manner, it is possible to effectively perform the recall job of the product.

Further, as described above, the code reading device 2 may read information on the price of the product, such as information that the product is free, information on discounts, such as a discount rate and discount amount, a price after discount, or the like, as information on the product. Furthermore, when the information on the price of the product is read, the code reading device 2 may output the information to another device, such as the POS terminal 3.

In addition, the code reading device 2 may distinguish the shape or color of the mark as the product information. For example, the code reading device 2 may determine the discount rate and output the discount information to the POS terminal 3. For example, the code reading device 2 may determine the discount rate is 50% when a red label is attached to a portion of the barcode symbol 61, and the discount rate is 30% when a blue label is attached to the barcode symbol 61.

In addition, in the above description, the determination unit 54 of the code reading device 2 determines whether or not the shelf line is expired, however, the determination may be performed by other units. For example, the code reading device 2 may output the read information on the shelf life to the POS terminal 3, and then the POS terminal 3 may determine whether or not the shelf life is expired.

Further, in the above description, a case of reading the barcode symbol as the code symbol is described, however, the above reading process may be performed with respect to other code symbols, such as a two dimensional code, or the like, including the barcode symbol. In this case, it is preferable that the print color of the two dimensional code symbol and the print color of “the product information” such as manufacturing date are printed to have a different color or a different density, respectively.

In addition, in the above description, product information, such as the barcode symbol 61, the shelf life, and the like, are printed on the label L, however the product information, such as the barcode symbol 61, the shelf life, and the like, may be directly printed on the product.

Further effects or modified examples may be easily derived by a person skilled in the art. Accordingly, further embodiments of the invention will not be limited to a specified details and representative embodiments which are described as above. Therefore, it is possible to make various changes without departing from a spirit or scope of the concept of the overall invention, which is defined by the accompanying claims and the equivalents thereof.

What is claimed is:

1. A code reading device comprising:
an image capturing unit which captures an image taken by an imaging element;
a code reading unit which reads code information included in a code symbol, from an image of the code symbol which is included in the captured image taken by the image capturing unit; and
an information reading unit which reads information relating to a product, which is overlapped with the image of the code symbol, from the image of the code symbol.

2. The code reading device according to claim 1, further comprising:
a determination unit which determines whether or not an image which is not the code symbol is overlapped with the image of the code symbol,
wherein, when overlapping of the images is detected by the determination unit, the image reading unit reads information relating to the product from the overlapped image.

3. The code reading device according to claim 1,
wherein, the information reading unit reads information on a shelf life of the product, as the information relating to the product.

4. The code reading device according to claim 3, further comprising:
a determination unit which determines whether or not the shelf life of the product is expired, using the information relating to the shelf life of the product, which is read by the information reading unit, and
a notification unit which informs that the shelf life of the product is expired, when the shelf life of the product is determined to be expired by the determination unit.

5. The code reading device according to claim 1,
wherein, the information reading unit reads information relating to a price of the product, as the information relating to the product.

6. The code reading device according to claim 5,
wherein, the information reading unit reads discount information on the product, as the information relating to the price of the product.

7. The code reading device according to claim 5, further comprising:
an output unit which outputs the information relating to the price of the product which is read, when the information relating to the price of the product is read by the information reading unit.

8. The code reading device according to claim 1,
wherein, the information reading unit reads information relating to manufacturing or production of the product, as the information on the product.

9. The code reading device according to claim 8,
wherein, the information reading unit reads a lot number of the product, as the information relating to manufacturing or production of the product.

10. The code reading device according to claim 9, further comprising:
a determination unit which determines whether or not the lot number of the product which is read by the information reading unit is the predetermined lot number, and
a notification unit which informs that the lot number of the product is the predetermined lot number, when the fact is determined by the determination unit.

11. A code reading method which is performed in a code reading device comprising the processes of:
an image capturing process in which an image taken by an imaging element is captured,
a code reading process in which code information included in a code symbol is read, from an image of the code symbol which is included in the captured image taken in the image capturing process, and
an information reading process in which information relating to a product, which is overlapped with the image of the code symbol is read, from the image of the code symbol.
